(19) United States
(12) Patent Application Publication
(10) Pub. No.: US 2011/0043847 A1
(43) Pub. Date: Feb. 24, 2011

(54) SYSTEM AND METHOD FOR ALLOCATING CONTENT OF ELECTRONIC DOCUMENTS

(75) Inventors: Amarnath Purohit, Rochester, NY (US); Padmarathan A. Raman, Pittsford, NY (US); Lewis S. Snow, La Crescenta, CA (US); Steven Schlonski, Webster, NY (US); Kirk Pothos, Webster, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/543,129

(22) Filed: Aug. 18, 2009

(51) Int. Cl. G06F 15/00

(52) U.S. Cl. 358/1.15

(57) ABSTRACT

A computer implemented document-processing system comprises at least one processing element including a receiving component, a target-region identifying component a database and a calculating component. The receiving component electronically receives a print-job specification corresponding to at least one printable document. The receiving component electronically stores the print-job specification. The target-region identifying component operatively identifies at least one target region of a printable document of the at least one printable document. The database stores a plurality of data sources and is in operative communication with the target-region identifying component. Each data source is configured to provide printable data for printing within a target region of the at least one target region received by the target-region identifying component. The calculating component electronically calculates a plurality of prices. Each price of the plurality of prices corresponds to printing the printable data within the target region of the at least one target region as received from a respective data source of the plurality of data sources. Each of the plurality of prices is operatively associated with a respective data source.

### CROSS-REFERENCE TO RELATED APPLICATIONS

This application is related to U.S. patent application Ser. No. ______ filed on Aug. 18, 2009 titled “System and Method for Processing Print Jobs” by Purohit et al.; U.S. patent application Ser. No. 12/427,001 titled “Campaign Management of Direct Mail” by Snow et al.; and U.S. patent application Ser. No. 12/426,978 titled “Automated Direct Mail Procurement System” by Snow et al.; the entire contents of the three applications are incorporated herein by reference.

### BACKGROUND

1. Technical Field

The present disclosure is generally related to print job processing, and more particularly, to a system and method for automatically determining content to be used in transpromotional printing.

2. Description of Related Art

Reverse auctions are commonly used to minimize the purchase price of items. In this style of auction, where the role of the buyer and the seller are reversed, the seller engages in competitive bidding in which items are offered for sale at a bid price of the seller's choosing. The buyer can select among the bids. Some reverse auction rules require the buyer to select the lowest bid. By engaging in a reverse auction, also referred to as a procurement auction, a buyer can sometimes purchase items at a lower price than are available through more typically used commercial channels. These reverse auctions can place downward pricing pressure on the sellers to cut costs, increase efficiency and/or minimize waste. Additionally, such auctions are sometimes used to facilitate business-to-business transactions.

Some reverse auctions are organized by a broker (sometimes referred to as a market maker) using a marketplace. The buyers and/or sellers contract with the broker to agree to be bound to the marketplace rules and procedures. The broker also provides consulting services and other market facilitating tasks. Some of the tasks the broker may perform include: organizing the marketplace rules and procedures, culling a list of capable sellers, authoring sellers, training sellers, interfacing the sellers into electronic aspects of the marketplace, organizing the auction, and providing auction data services to buyers and sellers. Some of the broker services sometimes include data services involving communication among sellers, buyers, and the marketplace. For example, the sellers and buyers may communicate with the marketplace using Extensible Markup Language (referred to as “XML”).

Advertising campaigns generally use a variety of advertising techniques. Purchases for items involving these techniques may be obtained in a variety of ways, including by outsourcing. During 2007, marketers in the U.S. spent a total of $55.3 billion in direct mail advertisements, driving $686.7 billion in sales. By 2012, it is anticipated that American businesses will spend $61.7 billion on direct mail advertisements. In comparison, $1.2 billion will be spent on e-mail marketing and $39.7 billion will be spent on Internet (non-e-mail) marketing. In 2012, 27% of marketing budgets will be allocated to direct mail advertisements.

### SUMMARY

In one embodiment of the present disclosure, a computer implemented document-processing system includes at least one processing component. The at least one processing component includes a receiving component, a target-region identifying component, a database and a calculating component. The receiving component includes a first buffer, and electronically receives a print-job specification corresponding to at least one printable document. The printable document may be in one configuration of a simple configuration, a reverse configuration, a fixed frame configuration, a contextual configuration, a cost leveraging configuration and/or a document-advisor created configuration. The receiving component stores the print-job specification in the first buffer. The target-region identifying component operatively identifies at least one target region of a printable document of the at least one printable document.

The database stores a plurality of data sources and is in operative communications with the target-region identifying component. The data source may correspond to an advertiser identifier, e.g., to receive data from an advertiser. Each data source is configured to provide printable data for printing within a target region of the at least one target region as operatively identified by the target-region identifying component.

One or both of the printable data and the printable document include(s) variable print data. The printable data may be a function of the printable document, an address of a destination of the printable document, a customer number associated with the printable document, a preference associated with the customer number, a location of the customer, and/or business data.

The calculating component includes a second buffer. The calculating component electronically calculates a plurality of weights, (e.g., price or a currency value). Each weight of the plurality of weights corresponds to printing the printable data within the target region of the at least one target region as received from a respective data source of the plurality of data sources. The plurality of weights may correspond to a reduction in cost of printing the printable document with the printable data. The second buffer stores the plurality of weights and each of the plurality of weights is operatively associated with the respective data source.

In another embodiment of the present disclosure, the document is a transpromo document. The target region is a white space of the printable document (e.g., the transpromo document) and the printable data is configured to print on the white space. The transpromo document may be an invoice, a statement, a 401k statement, an evidence of coverage, a contract, a proposal, a trade confirmation, a retirement document, a brokerage account information, an insurance policy, and/or a check. Additionally or alternatively, the transpromo document may be in color. The transpromo document may correspond to a transpromo job type selectable from a direct mail campaign catalog.

In yet another embodiment of the present disclosure, the receiving component electronically receives a campaign-specifications data structure including the print-job specification. The campaign specifications data structures can further include a job specification selected from a direct mail campaign catalog, a direct mail campaign advertising, and a direct mail non-printable services.

In yet another embodiment of the present disclosure, the system further includes an advanced sourcing workbench adapted to receive at least one advertiser preference. The advertiser preferences may includes one of a rate, a base rate and a cost per square inch. The advanced sourcing workbench may be further adapted to receive a vendor equipment capability configured to indicate a print capability. The print capability indicates the vendor's capability to print the printable document.

In another embodiment of the present disclosure, a method of document processing includes: receiving a print job specification for a printable document; identifying a target-region of the printable document; receiving printable data for printing within the target region of the printable document; and calculating a weight for printing the printable data positioned within the target region of the printable document. The method may further include: selecting a data source to provide the printable data for printing within the target region of the printable document; calculating a second weight for printing the printable document and/or offsetting the second weight for printing the printable document by the weight for printing the printable data positioned within the target region.

### BRIEF DESCRIPTION OF THE DRAWINGS

These and other advantages will become more apparent from the following detailed description of the various embodiments of the present disclosure with reference to the drawings wherein:

FIG. 1 shows a block diagram of a computer implemented document-processing system for processing advertisement campaign requests in accordance with the present disclosure;

FIG. 2 shows a more detailed view of the marketplace of FIG. 1 in accordance with the present disclosure;

FIG. 3 shows the catalog model of the direct mail campaign catalog in accordance with the present disclosure;

FIG. 4 shows three document types in accordance with the present disclosure;

FIG. 5 shows a transpromo document in accordance with the present disclosure;

FIG. 6 shows the vendor user interface of FIG. 2 as seen by an advertiser in accordance with the present disclosure;

FIG. 7 shows the vendor user interface of FIG. 2 as seen by a advertiser when submitting an advertiser relating to a 401K statement in accordance with the present disclosure;

FIGS. 8, 9, and 10 show various views as seen by a buyer when using the interface component of FIG. 2 to select a source to provide printable data in accordance with the present disclosure; and

FIG. 11 shows a method of processing documents in accordance with the present disclosure.

### DETAILED DESCRIPTION

Particular embodiments of the present disclosure are described herein below with reference to the accompanying drawings. In the following description, well-known functions or constructions are not described in detail to avoid obscuring the present disclosure in unnecessary detail.

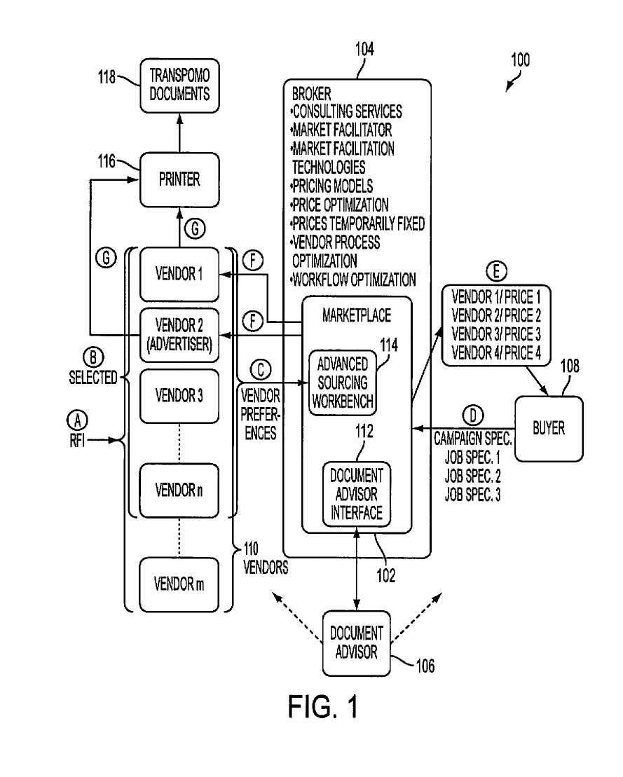

Referring to the drawings, FIG. 1 shows a block diagram of a system 100 at least partially implemented by a computer for processing documents in accordance with the present disclosure. System 100 includes a marketplace 102 organized and facilitated by a broker 104. The marketplace 102 may be implemented in hardware, software, software in execution, in virtualization, utilizing CPLDs, PALs, PLDs, FPGAs, one or more servers, firmware, bytecode, microcode, by an operative set of processor executable instructions configured by execution by at least one processor, or some combination thereof. System 100 includes stages A, B, C, D, E, F, and G. The stages may occur in serial, in parallel, step-wise, or otherwise in any ordering. The letter designation is only for ease of referencing within description herein.

Marketplace 102 is organized by broker 104. Broker 104 provides the marketplace 102 and facilitates transactions. The transactions may be facilitated by broker 104 by providing legal services, the contractual framework, and the market rules and procedures. Broker 104 also: (1) provides consulting services, (2) facilitates the market, (3) provides market facilitation technologies, (4) provides pricing models, (5) optimizes prices, (6) provides the legal framework so that prices are temporarily fixed during the bidding process, (7) provides vendor process optimization services, and (8) optimizes the workflow.

System 100 also includes document advisor 106 (referred to herein as “DA 106”). DA 106 can facilitate price optimization of print and non-print related commodities relating to advertisement campaigns and other print jobs. To conduct large scale enterprise style advertising campaigns, DA 106 procures a broad range of services and goods for buyer 108. These enterprise services may utilize different equipment, consumables, and associated data exchanges. Marketplace 102 enables DA 106 to procure a broader range of services as part of the advertising campaign including jobs having a job type selected from Direct Mail Campaign type jobs. Rather than having the DA 106 use non-standard tools to store and utilize data to procure various products through non-print market procurement techniques, which leads to loss of revenue for broker 104, marketplace 102 can facilitate procurement by buyer 108 of various job types related to advertising campaigns including non-print based services related to advertising campaigns. Some of these services may also be offered by broker 104 or may simply be facilitated by broker 104 using marketplace 102.

Some of the jobs required for these goods and services are available for procurement via marketplace 102 by procuring from one of vendors 110. Vendors 110 includes vendor 1 through vendor m (including vendor n). The letter n and m designates that an arbitrary number of vendors are used with n<=m. Some of the services offered by vendors 110 include job types chosen from: direct mail campaign catalogs, direct mail campaign advertising, and direct mail non-printable services, which are provided to buyer 108 along with direct mail campaign services (discussed in more detail below). Advertising services and nonprintable services are therefore deliverable in marketplace 102.

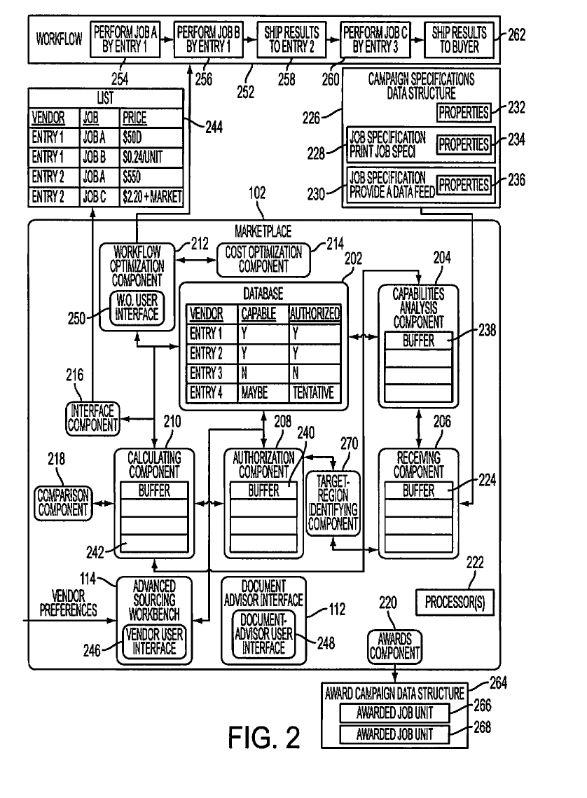

Additionally, one or more of vendors 110 may own, control, maintain, or contract to control printer 116. Printer 116 can print various print jobs including printable documents received as part of a print-job specification and/or as part of a printable data provided from a data source, resulting in transpromo documents 118. One or more printable documents may be combined with printable data received from a data source for sending to printer 116. The data source may be from one or more of vendors 110 and may include printable data to be printed within a target region of a document such as a white space (described in more detail below). Also, the data source may correspond to an advertiser identifier, e.g., the data source may be an identifier entry within a database 202 (see FIG. 2)

An advertising campaign may be considered as tying together several jobs, e.g., an advertising campaign is a container for multiple jobs. Jobs grouped into a campaign may inherit some properties from the campaign by default which is also discussed in more detail below. Each job may have multiple components as part of the specification. These workflows may be configurable by DA 106 depending upon the information entered via document advisor interface 112.

During stage A, requests for information (also referred to herein as “RFIs”) are submitted to vendors 1 through m to elicit information from vendors 110. Stage A may take up to nine months and may involve dozens of support individuals for the case where there are almost 300 vendors within vendors 110. After reviewing RFI submittals, stage B culls vendors 110 to select vendors 1 through n from vendors 110. During stage C, vendors 1 through n of vendors 110 enter vendor preferences including about 2,000 price points into a database 202 (see FIG. 2) through advanced sourcing workbench 114. An advertiser may also enter into the database 202 vendor preferences such as one or more advertiser preferences, e.g., a rate, a base rate and a cost per square inch. A vendor may also input an equipment capability such as the vendor's capability to print a printable document such as a transpromo document.

The database 202 is part of marketplace 102. Document advisor 106 may assist vendors 1 through n by reviewing and adjusting information including the vendor preferences, e.g., the price points, utilizing document advisor interface 112. Additionally or alternatively, document advisor 106 may further limit the list of authorized vendors that can participate in marketplace 102 transactions. One or more of vendors 110 may provide advertising related information via a data source and/or may providing printing services related to transactional documents, and may work together to generate transpromo documents 118 (described in more detail below).

During stage D, buyer 108 inputs a campaign-specification data structure, including one or more job specifications, into marketplace 102. The campaign-specification data structure may be in an XML format. One job specification received during stage D may be to print transactional documents including: an invoice, a statement, a 401k statement, an evidence of coverage, a contract, a proposal, a trade confirmation, a retirement document, a brokerage account information, an insurance policy, and/or a check. Another job specification received may be to offset the cost of printing the transactional document with printing advertisements thereon (described in more detail below) (e.g., a transpromo document).

During stage E, marketplace 102 determines which vendors are capable and/or are authorized to perform one or more jobs as specified by the job specifications of the campaign-specifications data structure, and generates a list of vendors capable of producing (or performing) the jobs along with a preview weight (e.g., a preview price) based on the rates collected during the sourcing effort, e.g., the vendor preferences entered during stage C. The weights may correspond to a currency value.

Additionally or alternately, advertisers may be authorized as a function a demographic profile and/or a consumer attribute. The calculating component may also utilize such data to calculate a plurality of weights having an association with the authorized set of entries, e.g., a price of using a particular advertiser.

When a group of vendors are selected for providing the campaign as specified by buyer 108, stage F sends that information to vendors 110. Vendor 1 may receive a job specification to print transactional documents and to receive a data source from vendor 2. Vendor 2 may provide a data source providing printable data for printing within a target region of a transaction document, e.g., forming a color transpromo document (described in more detail below). Vendor 2 is an advertiser. During stage G, vendor 1 sends information to printer 116 to print documents and vendor 2 either sends the data source directly to printer 116 (e.g., electronically) or sends it to vendor 1 for processing before (or simultaneously) being sent to printer 116. The resulting documents include transpromo documents 118.

An advertising campaign may have several job types, some of which may be related to additional unique jobs that are required to conduct an effective advertising campaign. For example, advertising campaigns may include several non-printable jobs such as legal and translation services, format conversions, and security services, each one depending upon other unique jobs required to perform those functions in a multi-varied advertising campaign production environment. When buyer 108 generates campaign-specifications data structures including several job specifications, the options are presented to buyer 108 based on the entered configurations and preferences entered into marketplace 102 via vendor preferences and/or via information communicated by document advisor 106.

Referring to the drawings, FIG. 2 shows a more detailed view of marketplace 102, also shown in FIG. 1, in accordance with the present disclosure. Marketplace 102 includes the document advisor interface 112, the advanced sourcing workbench 114, the database 202, a capabilities analysis component 204, a receiving component 206, an authorization component 208, a calculating component 210, a workflow optimization component 212, a cost optimization component 214, a interface component 216, a comparison component 218, an awards component 220, and a target-region identifying component 270. Marketplace 102 may be implemented utilizing one or more processors 222. Additionally or alternatively, marketplace 102 may utilize one or more memories, e.g., all buffers may be in a single memory or may be distributed among several memories.

Receiving component 206 includes buffer 224. Receiving component 206 electronically receives a campaign specification data structure 226, e.g., via an XML format. Campaign specification data structure 226 includes information to request advertising campaign goods and/or services and includes job specifications 228 and 230. Job specification 228, in an exemplary embodiment is a print-job specification corresponding to one or more pintable documents (e.g., transactional documents) having a one or more target regions, e.g., white spaces. The printable document may include variable print data. Job specification 230 in an exemplary embodiment provides a data source for providing printable data for printing within a target region of the transaction documents of job specification 228. The printable data may also include variable print data. The printable data may be a function of the printable document, an address of a destination of the printable document, a customer number associated with the printable document, a preference associated with the customer number, a location of the customer, and/or business data. Additionally or alternatively, the data source may correspond to an advertiser identifier as found in database 202.

Campaign specifications data structure 226 includes properties 232; and job specifications 228 and 230 include properties 234 and 236, respectively. A property 232 of campaign specification data structure 226 may be inheritable by a property of a job, e.g., a property of properties 234 may inherit from a property of properties 232. Additionally or alternatively, a property of a job specification may be bounded by a property of a campaign specification data structure, e.g., a property of properties 234 may be bound or constrained by a property of properties 232. For example in an embodiment of the present disclosure, a campaign property 232 includes a campaign due date that sets a bound on all jobs, thus a property 234 of job specification 228 being a job due date is bounded by the campaign due date.

As previously mentioned, the campaign specifications data structure includes job specifications 228 and 230. The job specifications 228 and/or 230 may be associated with a job type. The job types associated with job specifications 228 and/or 230 may be from a direct mail campaign catalog, direct mail campaign advertising and direct mail non-printable services. In an exemplary embodiment of the present disclosure, job specification 228 is associated with a job type for printing a transactional document which is a selectable job associated with a direct mail campaign catalog. Job specification 230 may be to provide a datasource for printing within a target region of the print-job specification of job specification 228. Target-region identifying component operatively identifies at least one target region of a printable document corresponding to the print-job specification 228.

Although campaign specifications data structure 226 is shown as having two job specifications, i.e., job specifications 228 and 230, campaign specifications data structure 226 may have more job specifications. Each job specification may by associated with a differing job type. Campaign specification data structure 226 may include information identifying requirements or preferences from a buyer for a campaign to be performed. For example, the campaign may involve several jobs which a buyer desires to procure and the buyer may transmit (e.g., via XML) to marketplace 102 describing the job the buyer is trying to procure.

Receiving component 206 receives the campaign specifications data structure 226 to electronically store it within buffer 224. Capabilities analysis component 204 is electronically coupled to receiving component 206. Capabilities analysis component 204 is also electronically coupled to database 202. Database 202 may be a SQL-based database and may include a plurality of vendor entries. Capabilities analysis 204 component includes a buffer 238. Capabilities analysis component 204 operatively and electronically receives the campaign-specifications data structure 226 from buffer 224 of receiving component 206. Capabilities analysis component 204 selects a set of capable entries from the database of vendors 202 and stores the selected set of capable entries in buffer 238. The selected entries from database 202 are vendors capable of performing one or more jobs as specified by campaign specifications data structure 226, e.g., entry 1 may be a vendor capable of performing job specification 228 while entry 3 is a vendor that cannot perform any jobs as specified by campaign specifications data structure 226. Although it is shown that capabilities analysis component 204 indicates a capability flag within database 202, it is considered equivalent for such capability to be indicated within buffer 238, within some other buffer, within memory of marketplace 102, and the like.

Authorization component 298 is also electronically coupled to receiving component 206 and to database 202. Authorization component 208 includes buffer 240. Authorization component 208 authorizes a set of entries of the database of vendors 202 conforming to a predetermined set of criteria. The authorized set of entries is stored in buffer 240 and is selected from capable entries and/or from database 202. The authorized set of entries includes advertisers authorized as a function of at least one of a demographic profile and a consumer attribute.

Marketplace 102 also includes target-region identifying component 270. Target-region identifying component 270 can review a print-job specification corresponding to a printable document to identify one or more target regions of a printable document. The database 202 includes a plurality of entries including data sources. The data source can provide printable data for printing within a target-region identified by target-region identifying component 270

Calculating component 210 includes buffer 242. Calculating component 210 electronically calculates a plurality of weight (e.g., prices) corresponding to campaign-specifications data structure 226 and stores the calculated weights (e.g., prices) in buffer 242. Each weight may be the price of a vendor performing a job, a total price from a vendor, a total price of a campaign based upon which vendor or vendors performs the jobs, and/or the price is a preview price based upon information from database 202. Comparison component 218 can determine the lowest weight from the plurality of weights associated with the authorized set of entries. The lowest weight may be flagged in calculating component 210 and/or may be communicated to a buyer, e.g., via interface component 216. A weight of the plurality of weights may also correspond to a reduction in cost of printing the printable document with the printable data, e.g., a transpromo document may be formed.

The weights from calculating component 210 may be communicated to a buyer via interface component 216. In addition, interface component 216 may electronically communicate (e.g., via XML) a list 244. List 244 may show the plurality of weights generated by calculating component 210. Each weight may be associated with an entry of database 202 (such as entry 1, which corresponds to a particular vendor). Each weight may be mapped to one or more capable and/or authorized entries in database 202 (e.g., via association of being a data structure within list 244). The prices in list 244 may be various prices corresponding to an entry performing a job, one or more entries performing one or more jobs, and/or may be a preview weight to start negotiations.

Marketplace 102 may also include advanced sourcing workbench 114 including vendor user interface 246. Vendor user interface 246 may be XML based, graphical user interface based, a client application running on a personal computer, php-based and running on a sever, and the like. Advanced sourcing workbench 114, in communication with database 202, can view or determine which of the vendors have been selected for sourcing. Each vendor that has been selected for sourcing can communicate a vendor preference to database 202 utilizing the vendor user interface 246 of said advanced sourcing workbench 114. The vendor preferences communicated may be vendor capabilities and/or vendor prices corresponding to a vendor job to be performed. These prices may be “rates”, total price, formulae, and the like.

As previously mentioned, authorization component 208 authorizes a set of entries of the database of vendors 202 conforming to a predetermined set of criteria and/or may be a constraint corresponding to the vendor preferences. Also, marketplace 102 includes document advisor interface 112 which includes a document-advisor user interface 248. Document-advisor user interface 248 is in electronic communication with a document advisor. The document advisor can utilize the document-advisor user interface to review the vendor preferences submitted to database 202, delete the vendor preferences, modify the vendor preferences, re-categorize the vendor preferences, authorize or de authorize entries in database 202, and select which vendors are capable, e.g., set which vendors are capable of performing a job and/or a campaign.

Marketplace 102 also includes workflow optimization component 212 including workflow optimization user interface 250. Workflow optimization component 212 can generate workflow 252. Additionally or alternatively, workflow optimization user interface 250 can receive input from a user to control the generation workflow 250. Workflow 252 may also be communicated to a buyer and may be associated with a price within list 244. Cost optimization component 214 may optimize workflow 252 to minimize the price a buyer pays to perform a campaign as specified by campaign specifications data structure 226. Cost optimization component 214 and workflow optimization component 212 may work together to generate workflow 252.

Workflow 252 includes job units 254, 256, 258, 260, and 262. Job units may correspond to a job specification 228 or 230. Additionally or alternatively, one of the job units 254, 256, 258, 260 or 262 may link together jobs. Job unit 254 is for job A to be performed by entry 1. Job unit 256 is for job B to be performed by entry 1. Job unit 258 is to ship the results to entry 2. Job unit 260 is for entry 3 to perform job C. Job unit 262 is for entry 3 to ship the results to the buyer. As shown in workflow 252, the workflow may utilize more than one vendor. Workflow 52 may correspond to a job specification, a campaign specifications data structure, and the like.

Consider the exemplary embodiment: Job unit 254 analyzes information to generate targeted advertising information; Job unit 256 provides printable data; Job unit 258 electronically sends information to a vendor that provides printing services. Job Unit 260 prints transpromo documents and job unit 262 mails the transpromo in a targeted way.

Marketplace 102 also includes awards component 220. Awards component 220 generates an award campaign data structure 264 corresponding to campaign-specification data structure 226. Awards campaign data structure 264 includes awarded job units 266 and 268 corresponding to job specifications 228 and 230, respectively.

As mentioned above, job specifications of campaign specification data structure 226 may be a job type selected from a direct mail campaign catalog, a direct mail campaign advertising and direct mail non-printable services. The selectable job types selectable from each of these will now be discussed in more detail below.

Direct Mail Campaign Catalog

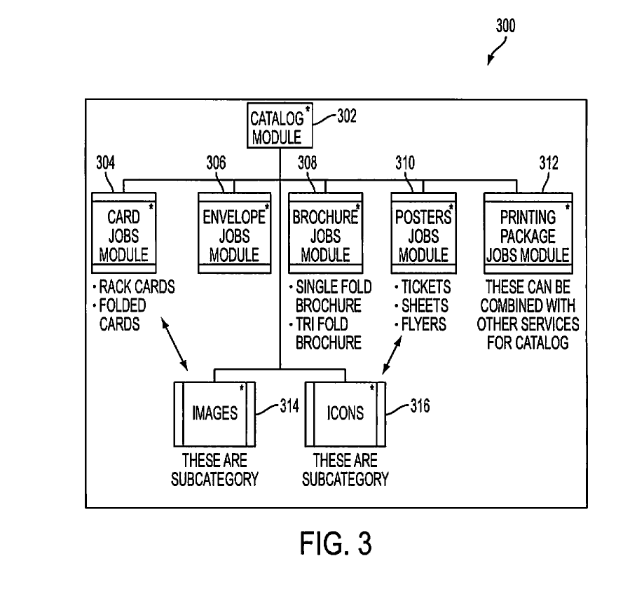

Referring to FIG. 3, direct mail campaign catalog structure 300 is shown. Structure 300 includes catalog module 302, card jobs module 304, envelope jobs module 306, brochure jobs module 308, poster jobs module 310, and printing package jobs module 312. Structure 300 also includes sub categories of images 314 and icons 316. Structure 300 may be a data structure, a database structure, an organization structure, a job type structure, and the like.

For card jobs module 304, the buyer can create one or more card jobs that are specified to be created from a master design or an aggregation of other pieces from the direct mail job that may be processed and/or personalized during the manufacturing process. Multiple card services may also be part of direct mail campaign catalogs that are related to card jobs. Card jobs may include pricing information (or may be considered a type of job) and can include card paper, card ink, aqueous coatings, rack cards, post cards, folded cards and the like. The print type of the cards can be determined by an algorithm for direct mail printing such that optimal print type for the job specification is calculated. The job specification 228 and/or 230 (of FIG. 2) may be created based on paper options, e.g., 120# Gloss Cover or 100# White Cougar Cover and etc. The data collection is done through the sourcing engagement where the Request for Proposal (RFP) is created for each service and a grid is created which is dynamic so that different paper options could be supported during RFP creation.

For the envelope jobs module 306, workflow 252 of FIG. 1 may be used such that the buyer can create one or more envelope jobs that specify the creation of masters or other pieces for direct mail that will be processed and personalized in the manufacturing process. To source and print envelop jobs, multiple card services may be created. Each service may have single or multiple pricing points. Envelope services may include envelope prepress, envelope press, envelope paper, envelope ink and the like. A software program includes an algorithm that determines an optimal price to be used in direct mail printing as specified by job specifications 228 and/or 230 of FIG. 2.

For brochure jobs module 308, workflow 252 of FIG. 2 may be tailored such that the buyer can create one or more brochure jobs and require the creation of masters or other pieces for the direct mail job that will be processed and personalized in the manufacturing process. To source and price brochure jobs, multiple card services are created. Each service may have single or multiple pricing points. Brochure services include brochure size, brochure paper, brochure ink, aqueous coating, folding, brochure type, single-fold, tri-fold, and the like. A computer application includes a print type determination algorithm to calculate the optimal print type for job specifications 228 and/or 230 of FIG. 2. Job specification 228 and/or 230 may correspond to brochure size, paper options, ink, aqueous coating, folding, and the like. Rates for these services are collected through sourcing and an optimum price calculation may correspond to a vendor based on the job specification, e.g., job specifications 228 and/or 230 of FIG. 2.

For poster jobs module 310, workflow 252 of FIG. 2 may be generated such that the buyer can create one or more poster jobs that require the creation of masters or other pieces that will be processed and personalized in the manufacturing process. To source and price poster jobs, multiple card services are created. Each service may have single or multiple pricing points. Poster services include poster paper, posters ink, aqueous coating, poster type, e.g., tickets, sheets and flyers, and the like. A computer application can include a print type determination algorithm that calculates the optimal print type corresponding to job specifications 228 and/or 230. The price calculation may be based on the quantity and the services offered. The catalog component workflow can use multiple components such that the manipulations of catalog products into individual pieces for the distribution process are possible.

Transpromo Documents

A transpromo document may be printed and be associated with one or more jobs from the Direct Mail Campaign Catalog. To generate a transpromo document, a vendor 110 of FIG. 1 that is an advertiser can bid for white spaces on a transactional document. After printing advertisements on the white space of a transactional document, a transpromo document is formed. These Transpromotional (also referred to as “transpromo documents”) allows buyer 108 to generate revenue on a campaign utilizing the Direct Mail Campaign Catalog as shown in FIG. 3 by buyer 108. Savings can be made by buyer 108 by offsetting the cost of printing the transactional document by including these advertisements. Transactional documents are necessary for many businesses and include invoices and statements. These documents are clearly a major focus for corporate printing.

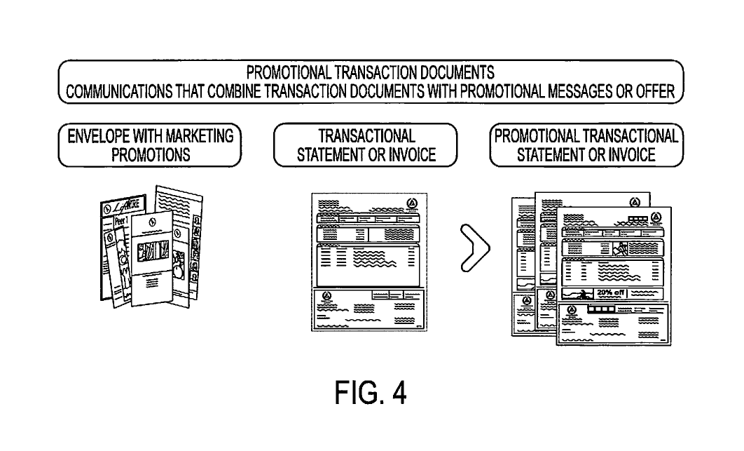

A “TransPromo” document is the combination of transactional document with promotional materials integrated together in a single document. Referring to FIG. 4, an example of a transpromo document formation is shown by combining an envelope with a marking promotion. These are combined with transactional statements or invoice which together form promotional transactional statement or invoices, e.g., transpromo documents.

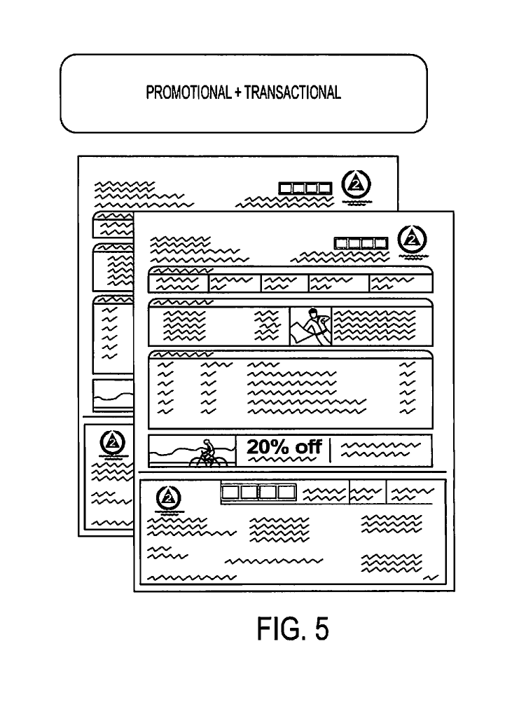

FIG. 5 more clearly shows a transpromo document including material sometimes marketed on an envelope and/or is inserted into the envelope. The advertisement may come in the form of print data and the transactional document may be a print job having white spaces. The white space may be managed by target-region identifying component 270 (see FIG. 2).

Transpromo documents can: (1) provide added value and service to broker 104; (2) reduce costs of buyer 108 and make it a potential profit for buyer 108 and/or broker 104; (3) provide a unique customer experience of allowing bidding on white space; and/or (4) be a marketing tool for broker 104 (see FIG. 1).

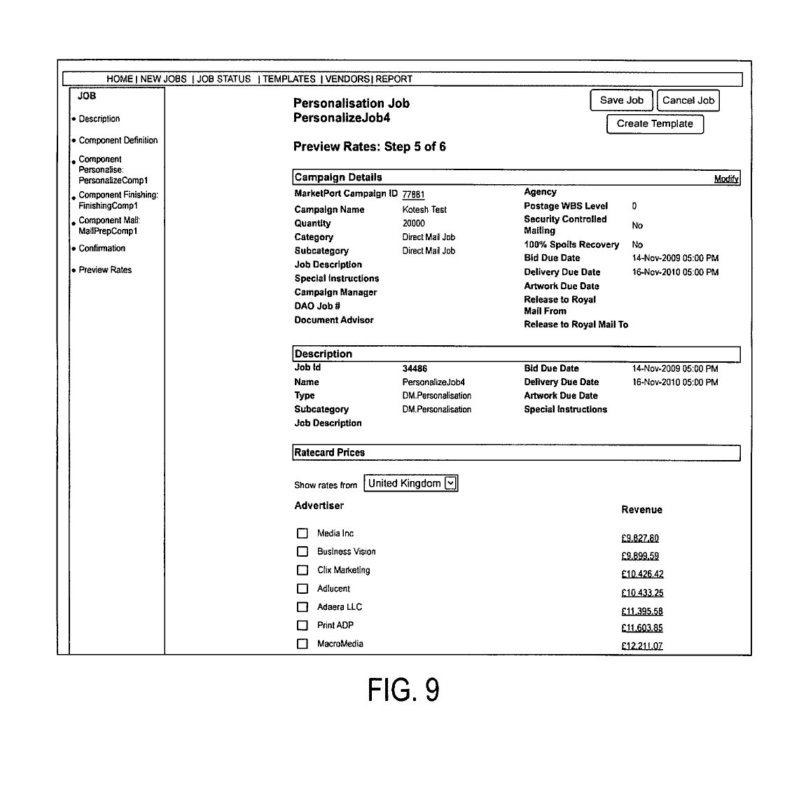

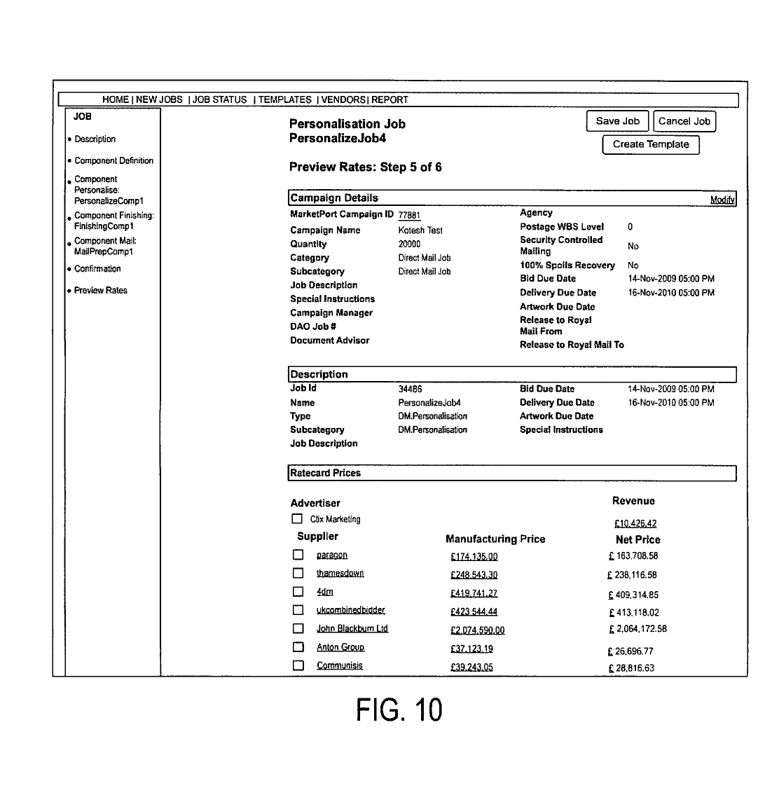

An advertiser can provide the rate data on each price point and service as is shown in FIG. 9. FIG. 9 also shows the amount offered to allow their advertising data to be printed on a white space. A vendor 110 (see FIG. 1) that is an advertiser can utilize the white space on transaction documents to target recipients with specific messages relevant to their buying patterns and preferences as outlined in FIG. 10. Note in the description portion, the “type” includes personalization, indicating that the advertising information is targeted. Broker 104 can work with document advisor 106 to finalize the list of advertisers from vendors 110 that could be engaged in the sourcing and bidding to provide the advertising space based on the variable data printing used in the transactional print job and/or the advertising print data (see FIG. 1)

Referring to FIG. 1, the list of vendors 110 that can be utilized during the bidding process may be based on profiling information including demographic and consumer attributes. This type of location intelligence can enable advertisers included within vendors 110 to explore, analyze and respond to relationships between the physical location of a prospective buyer and the business data. Once the list of vendors 110 is finalized, the approved advertisers are invited to bid on the transpromotional documents space(s).

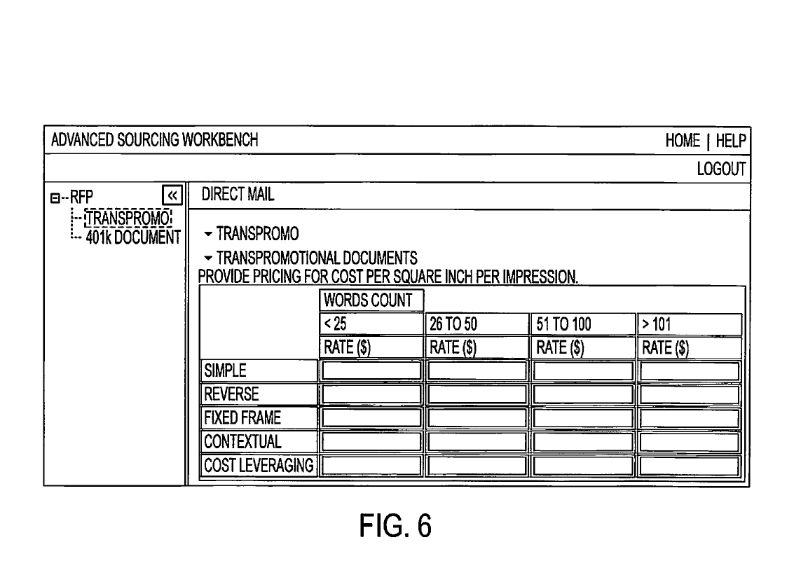

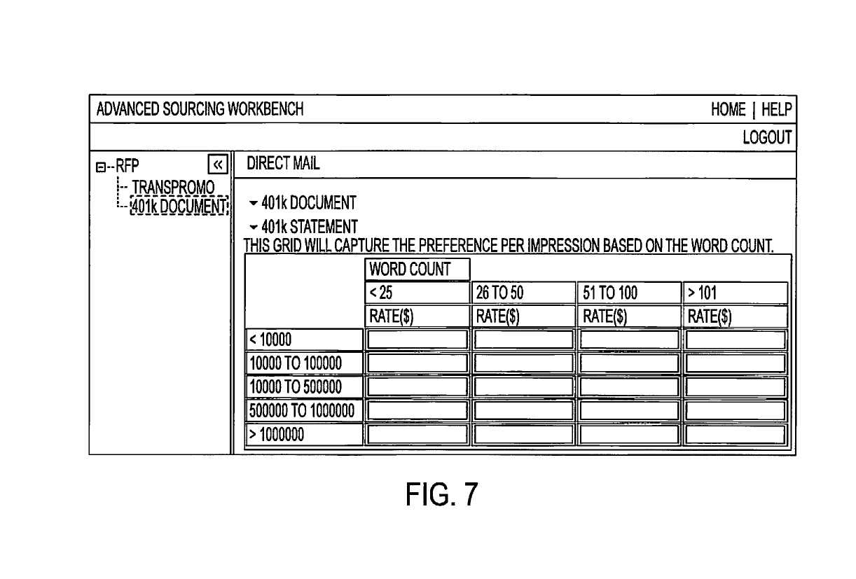

Referring to FIG. 6, advertiser preferences are entered into the GUI as shown. The advertiser preferences may be evaluated based on the cost per square inch per impression. The grid as shown in FIG. 7, is an example of a user interface as seen by an advertiser for entering advertising related data, such as rates, on a 401(k) document. A different RFP for each form type can be designed based on the Buyer 108's and advertiser of vendor 110's specifications. The list of supported types may include, among other things: statements, invoices, evidence of coverage, contracts, proposals, trade confirmations, 401k or other retirement documents, brokerage account information, insurance policies, checks, and the like. The transpromo workflow can be available to document advisor 106 depending on the particular embodiment. Vendors 110, who possess printing capability, can map their equipment to the functionality through the vendor preferences configuration.

TransPromo job types include various configurations such as simple, reverse, fixed frame, contextual, and cost leveraging. In the simple configuration, the remaining space at the end of the last page of the transactional document is filled with promotional message. The advertising data may be ordered in such a way that the advertisements are printed in a linear global priority order. In the reverse configuration, the document is composed virtually (e.g., rendered and/or rastered) so that target-region identifying component 270 determines the amount of available white space. The determined white-space is then filled on the front page, maximizing the visibility of the message. In the fixed frame configuration, white space is reserved for messages; static frames are placed in the document as placeholders for messages.

In the contextual configuration, the white space is analyzed after the transaction data is processed and the advertisement data is chosen such that it is relevant to the item it is near. For Example: a cable bill using contextual white spaces might place an internet promotion near internet details, cable promotions might appear near the cable details, and pay-per-view promotions might be placed at the front of the document if the subscriber did not purchase pay-per-view services during the billing period. In the cost leverage configuration, the production cost of the document may be considered as an investment. For example, once a transactional document crosses a postal rate threshold, the message space may be increased at a small incremental cost. Cost leveraging configuration can continuously calculate the weight of the piece, recheck the placement of pieces in the mailing trays and generate new postal paperwork to reflect any changes.

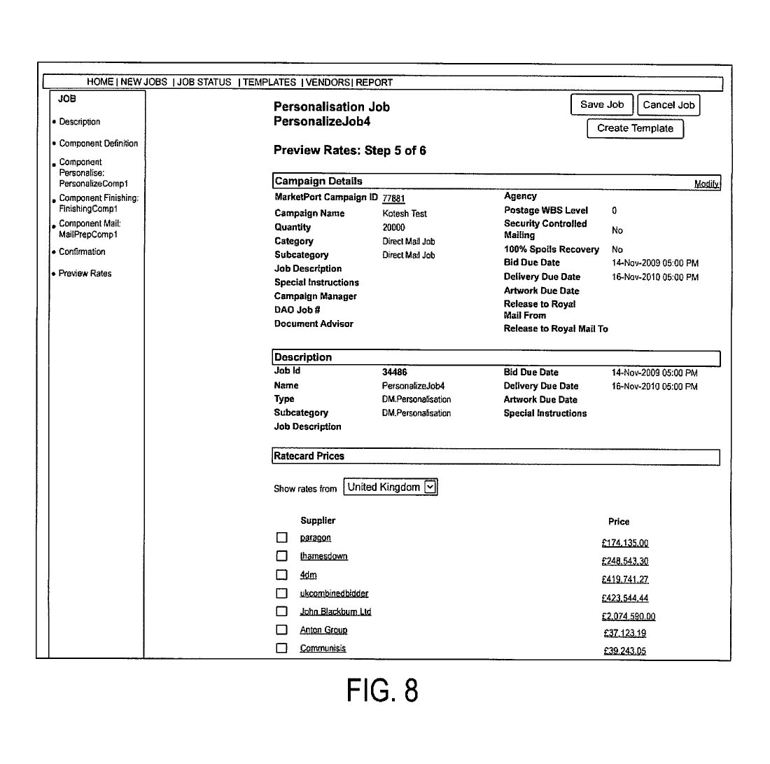

Vendors 110 could configure different form types based on a vendor preference setup as shown in FIGS. 6 and 7. If the rates are available, the list of capable vendors for the job is generated and the bidding process starts as shown in FIG. 8. In addition, the projected revenue can be displayed based upon which advertiser is chosen as shown in FIG. 9.

FIG. 10 shows the offset costs as provided by an advertiser which may be compared to the cost of printing the transactional documents. Note that the net price is the cost of printing the transactional document minus the money collected from using the white space to advertise on the transactional document.

Direct Mail Campaign Advertising

The direct mail campaign advertising may include mail preparation, shipping services, direct mail targeting services, market research, newspaper insert services, campaign results services, and newspaper insert services for job type selection. Advertising can utilize mail preparation services and other delivery services to ship advertising materials including post cards, letters, brochures, catalogs, and flyers. Campaign specification data structure 226 of FIG. 2 may request creative, responsive generation of adverting material. Utilizing a direct mailer assists in targeting the people and businesses most likely to respond, avoids wasting money on sending mail to those you will never hear back from, and achieves a higher return on investment. The direct mail campaign advertising services include a full range of different options suited to meet campaign needs. Direct Mail campaign advertising can be a very cost effective way of advertising, especially if mailings contain printed material. This is due to cost advantages obtained by printing in high volume, since the majority of print costs are realized when a printing machine is initially setup to run a print job and not because of the quantity of material printed. Thus, the total coast of printing 50,000 postcards is only slightly higher than printing 20,000 postcards, but when the total cost is divided by the number of cards printed, the cost per card drops more dramatically as more pieces are printed.

Advertising jobs, which can include, among other things, market research, newspaper inserts, evaluation of campaign results services, and the like, may be modeled with components. A newspaper insert component allows the creation of job specifications 228 and/or 230 (see FIG. 2) such that capable vendors can have a price preview calculated to give the best possible rates to buyers for different types of the newspaper inserts. When the newspaper insert component is utilized, the following options are available as part of job specifications 228 and/or 230: inserts with different shapes, inserts with different objects (e.g., keys, CDs, coins, stamps), and the like. Shipping and delivery requirements are defined within job specifications 228 and/or 230. A market research component allows specifications 228 and/or 230 to manage the advertising campaign and corresponds to the following services: media market research services (which define the advertising channels) and geographic scope services (which define the scope of the campaign (e.g., international, regional, local), and the like. A campaign evaluation service may be used to measure the results of carrying out the campaign (such as pre-campaign measurement and post-campaign measurement of the customer awareness).

A separate direct mail organization would be created to access vendors with direct mail capability (this could be done on the buying organization level rather than per job level). Vendors can configure different advertising media capabilities. Job optimization can include using the most economical advertising service. If the rates for a service are available, the list of capable vendors for each campaign advertising job within the campaign is generated and the bidding process can start. Campaign functionality may also manage information from each campaign advertising to calculate the best preview price and best vendor. After the bidding process is completed, the buyer can award each individual advertising job contained within the campaign to selected vendors. The campaign modality allows jobs to be split among multiple capable vendors (with the campaign as the “sum of the whole”). Overall, this process will allow buyers (DAs) to include campaign advertising as part of the direct mail campaign in the total print volume they procure for their clients and thereby achieve greater savings.

Direct Mail Non-Printable Services

Direct mail non-printable services also includes several job types giving a buyer the ability to add non-printable services including legal services, notary services, translation services, file conversion services, security services, and the like. To be able to price these services, workflow 252 of FIG. 2 can include these therein. Each workflow has an associated job type. Direct Mail non-printable services include job types of campaign legal jobs, campaign translation jobs, and the like. Each of these jobs may have different components.

For legal services, the legal job allows job specifications 228 and/or 230 to facilitate a buyer to “find” capable vendors, display preview prices for each vendor for performing the job, and find the best rates for the copyright services, hourly training services, direct mail notary services, and the like. The pricing for these services could be based on the rate cards rates collected through the sourcing process as well as non rate card pricing based on the capable vendors bid and/or vendor preferences.

The translation services allow the DA to execute the multilingual campaign in a personal, timely, and affordable manner. To be able to create and price the translation services, a direct mail translation component may be used. This component can be defined within job specifications 228 and/or 230. For the direct mail campaigns translation services, the preview price would be calculated based on the vendor rates available through the bidding process. Different pricing models are available based on the vendor preferences including by pricing per lines count, hourly-based prices, and the like.

These aspects of a campaign enhance the business process of the campaign because now buyers have the ability to model and price all activities by creating the campaign specifications data structure 226 starting from the marketing perspectives and to the estimation of the effectiveness of the direct mail campaign.

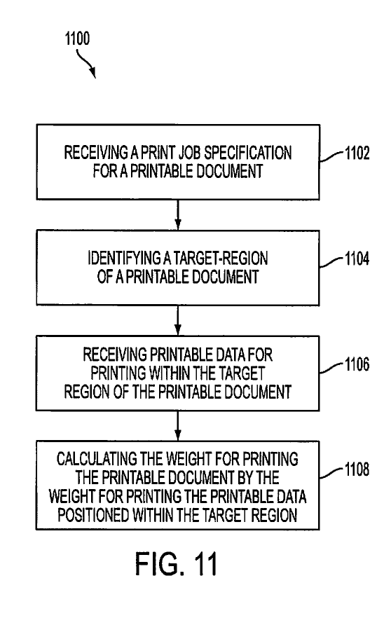

Referring to the drawings, FIG. 11 shows a method 1100 of processing documents in accordance with the present disclosure. 1102 includes receiving a print job specification for a printable document; 1104 includes identifying a target-region of the printable document; 1106 includes receiving printable data for printing within the target region of the printable document; and 1108 includes calculating a weight for printing the printable data positioned within the target region of the printable document.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A document-processing system, comprising:
a processor; and
a computer-readable storage medium in communication with said processor, wherein the computer-readable storage medium comprises one or more programming instructions for:
providing an electronic document including a sheet having a print data portion and a white space portion,
automatically configuring the print data portion relative to the white space portion in accordance with one of a plurality of preset configuration approaches,
receiving at least one bid from a group of vendors for printing at least the electronic document,
electronically designating one of the group of vendors to process a transpromotional job including the electronic document,
referring to a list corresponding to a plurality of advertisers each having an association with a revenue amount, and
electronically designating one of the advertisers as the advertiser who will supply an advertisement for use within the white space portion.

2. The system according to claim 1, wherein the one of the plurality of preset configuration approaches is a simple configuration and the computer-readable storage medium further comprises one or more programming instructions for:
automatically configuring the print data relative to the white space portion such that the white space portion is any remaining non-print data portion of the electronic document.

3. The system according to claim 1, wherein the one of the plurality of preset configuration approaches is a reverse configuration and the computer-readable storage medium further comprises one or more programming instructions for:
electronically composing the document;
electronically determining an amount of the print data portion;
electronically designating any non-print data portion as the white space portion; and
printing the advertisement within the white space portion on a front page of the sheet thereby maximizing the visibility of the printed advertisement.

4. The system according to claim 1, wherein the one of the plurality of preset configuration approaches is a fixed frame configuration and the computer-readable storage medium further comprises one or more programming instructions for:
electronically reserving a portion of the electronic document;
electronically placing a static frame within the electronic document thereby reserving the portion of the electronic document; and
electronically designating a portion of the reserved portion of the electronic document as the white space for printing the advertisement therewithin.

5. The system according to claim 1, wherein the one of the plurality of preset configuration approaches is a contextual configuration and the computer-readable storage medium further comprises one or more programming instructions for:
analyzing the print data;
determining a context of the print data;
selecting an advertisement based upon the determined context of the print data; and
electronically designating a portion of the white space for printing the advertisement closest to the region of the print data defining the context.

6. The system according to claim 1, wherein the one of the plurality of preset configuration approaches is a cost leveraging configuration and the computer-readable storage medium further comprises one or more programming instructions for:
determining a production cost of printing the electronic document;
readjusting the size of the white space;
determining an increase in revenue generation based upon the readjusted size of the white space;
determining at least one of a weight and an increase of weight as a function of the readjustment; and
electronically calculating a post rate as a function the at least one of the weight and the increase of the weight.

7. The system according to claim 1, wherein the one of the plurality of preset configuration approaches is a document-advisor created configuration and the computer-readable storage medium further comprises one or more programming instructions for:
automatically receiving an instruction from a document advisor for configuring at least one of the print data and the white space; and
configuring the at least one of the print data and the white space.

8. A computer implemented document-processing system, comprising:
at least one processing component, including:
a receiving component for electronically receiving a print-job specification corresponding to at least one printable document, the receiving component electronically storing the print-job specification;
a target-region identifying component operatively identifies at least one target region associated with the at least one printable document;
a database for storing a plurality of data sources, said database in operative communication with said target-region identifying component, wherein each data source provides printable data for printing within a target region of the at least one target region as operatively identified by the target-region identifying component; and
a calculating component for electronically calculating a plurality of prices, each price of the plurality of prices corresponds to printing the printable data within the target region of the at least one target region as received from a respective data source of the plurality of data sources, wherein the calculating component electronically stores the plurality of prices and each of the plurality of prices is operatively associated with the respective data source.

9. The system according to claim 8, wherein the at least one printable document comprises a transpromo document.

10. The system according to claim 8, wherein the target region is a white space of the printable document, the printable data being configured to print on the white space.

11. The system according to claim 9, wherein the transpromo document is one of an invoice, a statement, a 401k statement, an evidence of coverage, a contract, a proposal, a trade confirmation, a retirement document, a brokerage account information, an insurance policy and a check.

12. The system according to claim 9, wherein the transpromo document corresponds to a transpromo job type selectable from a direct mail campaign catalog.

13. The system according to claim 8, wherein at least one of the printable data and the printable document includes variable print data.

14. The system according to claim 8, wherein said receiving component electronically receives a campaign-specifications data structure including the print-job specification, wherein the campaign specifications data structure further includes a job specification selected from a direct mail campaign catalog, a direct mail campaign advertising, and a direct mail non-printable services.

15. The system according to claim 8, wherein the printable data is a function of one of the printable document, an address of a destination of the printable document, a customer number associated with the printable document, a preference associated with the customer number, a location of the customer, and business data.

16. The system according to claim 8, further including an authorization component adapted to authorize a set of entries within the database, wherein the authorized set of entries includes advertisers authorized as a function of at least one of a demographic profile and a consumer attribute, wherein the calculating component electronically calculates a plurality of prices having an association with the authorized set of entries.

17. The system according to claim 8, further including an advanced sourcing workbench adapted to receive at least one advertiser preference.

18. The system according to claim 17, wherein the at least one advertiser preference includes one of a rate, a base rate and a cost per square inch.

19. The system according to claim 17, wherein the advanced sourcing workbench is further adapted to receive a vendor equipment capability configured to indicate a print capability, the print capability indicating the vendor's capability to print the printable document.

20. The system according to claim 8, wherein each weight of the plurality of prices corresponds to a reduction in cost of printing the printable document with the printable data.

21. The system according to claim 8, wherein the printable document is in one configuration of a simple configuration, a reverse configuration, a fixed frame configuration, a contextual configuration, a cost leveraging configuration and a document-advisor created configuration.

22. A method of document processing, comprising:
receiving a print job specification for a printable document;
identifying a target-region of the printable document;
receiving printable data for printing within the target region of the printable document; and
calculating a price for printing the printable data positioned within the target region of the printable document.

23. The method according to claim 22, further including:
calculating a second price for printing the printable document; and
offsetting the second price for printing the printable document by the price for printing the printable data positioned within the target region.

24. The method according to claim 22, further including selecting a data source to provide the printable data for printing within the target region of the printable document.
